(19) United States
(12) Patent Application Publication
(10) Pub. No.: US 2008/0244565 A1
(43) Pub. Date: Oct. 2, 2008

(54) Dynamic software installation and configuration

(75) Inventors: Bjorn B. Levidow, Bellevue, WA (US); Israel Hilerio, Redmond, WA (US); Eric B. Watson, Redmond, WA (US); Lingan Satkunanathan, Kirkland, WA (US); Edward Tremblay, Redmond, WA (US); Dmitry Sonkin, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/729,491

(22) Filed: Mar. 29, 2007

(51) Int. Cl. G06F 9/445; G06F 17/30; G06F 9/46

(52) U.S. Cl. 717/176; 707/3; 718/100

(57) ABSTRACT

A setup workflow may be defined in a complex workflow manner that may have branching, error compensation, and relationships defined between a software product to be installed and previously installed or future products that may be installed. As a setup workflow operates, a remote device may be contacted for an updated setup step that may also include relationship definitions between the new setup step and other steps or installed components. The new step may be for a remotely provided service that may be used in lieu of a locally installed product. The setup workflow may include dependencies and coordinate setup workflows across multiple devices.

### BACKGROUND

Setup of computer devices may become quite complex, especially when several interrelated components are being deployed. In some instances, a component may be developed by one manufacturer, but may have dependencies on other components developed by other manufacturers. This may be especially true for server devices that provide complex services to client devices over a network. In many cases, computer consultants with considerable experience may be used to determine how to configure various software components to operate in harmony.

In many cases, a particular software function may be provided through local operation as well as through a service provided over a network, including the Internet.

### SUMMARY

A setup sequence may be defined in a complex workflow manner that may have branching, error compensation, and relationships defined between a software product to be installed and previously installed or future products that may be installed. During a setup sequence, a remote device may be contacted for an updated setup step that may also include relationship definitions between the new setup step and other steps or installed components. The new step may be for a remotely provided service that may be used in lieu of a locally installed product. The setup sequence may include dependencies and coordinate setup workflows across multiple devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The workflow definition may be adaptable to modification during execution by adding, removing, or changing a task definition dynamically. A query to a remote server may return updated setup task metadata that defines changes to the workflow structure. The remote server may also return executable or other definitions for a new setup task module that is performed to accomplish the new task.

For the purposes of this specification, the terms “installation” and “setup” are used synonymously to refer to a process of putting a program, operating system, application, or other software component on a system so that the software may be used. The terms may also include configuring a hardware device or any other preparatory actions used to prepare a device for use. In some instances, the installation process may be installing data files that are not executed, while in other instances, the process may include installing executable or interpretable software functions or programs. Installation may also include performing steps that have a net result of having a component function differently or having a set of components function differently.

Further, the term “workflow” is used in a generic sense to refer to any type of definition of a sequence or method. In some cases, such a definition may be a simple, serially executed sequence of steps. In other cases, such a definition may include complex branching, parallel processing, multithreading, interdependent processes, or any other definition of a process.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

FIG. 1 is a diagram of an embodiment 100 showing a system with a workflow based setup. A device 104 may perform a setup workflow to install and configure services. While performing the workflow, updates to the workflow may be obtained from an update server 120. The updates may include changes to the workflow to newer versions of specific products or for providing up to date options for a user to select, including alternatives such as obtaining a software service from a remote service provider 134.

The workflow may be adapted to perform installations on the device 104 as well as on other devices such as device 136. A setup workflow operating on the device 104 may operate in conjunction with a setup workflow on device 136. In another embodiment, a setup workflow may include tasks by which device 104 may install a component on device 136.

Setup workflows may define a method, process, or sequence by which setup tasks may be performed. The workflows may be defined in a specialized language such as Extensible Application Markup Language (XAML) or any other mechanism by which a process may be defined, including state machines, object oriented definitions, or other such mechanism. XAML is a specific implementation of the Extensible Markup Language (XML).

Setup tasks may be any process used to install, configure, setup, or otherwise prepare a device to perform or use a product. The product may be a software product that has executable or interpretable code on a local storage system for processing on a local processor. In some instances, the product may be a service that is performed by a remote service provider. In still other instances, the product may be a software application, system, or component that operates on another device. In such instances, the product may operate in conjunction with other products on a local device. In other instances, the software product on the other device may operate on a standalone basis.

Installation of modem operating systems, application suites, server applications, or other complex products may have many components within the product that interact. Further, when multiple products are put together in a device or set of devices, the complexity of the installation may increase dramatically, especially when multiple products come from different vendors.

The definition of a workflow may include implied or express dependencies between different steps or tasks. The dependencies between various tasks may include dependencies on product installation that may or may not be part of the current workflow. In some embodiments, a new task may be added during an update sequence and may have dependencies defined that cause the workflow to add additional steps to include other products, services, or configurations on which a new task depends.

The workflow may also include error capture and recovery sequences that may enable the workflow to revert to a previous configuration state and redo a process or present a user interface so that a configuration may be changed and the task reattempted. As each task is completed during a workflow process, a configuration state associated with the task may be defined. If an error occurs in a task that depends on a specific task, the workflow may cause the process to revert to a state before the task was performed so that a user may be able to change a setting or parameter and retry the task.

The device 104 is connected to the network 102 through a network interface 106. The device 104 has a processor 108 that may execute a workflow and various associated tasks to perform an installation or setup routine. The processor 108 may install components on a storage system 110 or perform other setup tasks.

Setup media 112 may contain a task workflow 114 and various task modules 116. In many cases, the setup media 112 may be mounted on a locally connected device such as a Digital Versatile Disk (DVD), Compact Disk (CD), or other media. In some cases, the setup media 112 may be located on another device and accessed through the network 102 and sometimes over the Internet 118.

The task workflow 114 may be a workflow definition that is a starting point for an installation or setup routine. As the workflow is executed, the workflow may be modified by updating one or more tasks during the workflow execution.

The task modules 116 may be definitions of tasks performed as part of the workflow. In some instances, the various task modules 116 may be separate executable files that perform specific tasks. In other instances, some of the task modules 116 may be subroutines, functions, classes, or other portions of executable or interpreted files that perform a setup task. Some embodiments may be designed so that each setup task performs a relatively large task, such as installing a software application or configuring a remote service. Other embodiments may be designed so that each setup task performs a more granular task, such as installing a specific function used by an application. In such embodiments, several tasks may be used to perform an installation of a single application. Some workflow definitions may comprise a handful of steps while other workflow definitions may comprise hundreds or even thousands of steps or individual tasks.

During the execution of a workflow, the device 104 may perform a query to a remote update server 120 through the Internet 118 or other network connection. A query may include a request for updates to the workflow or new tasks.

The update server 120 may have updated setup media 122 that contains new task metadata 124 with dependencies 126 for the new task. Along with the metadata 124, new task modules 128 may also be available.

The update server 120 may provide new task metadata 124 and dependencies 126 that may be incorporated into the workflow 114 that may be executing. In some instances, the update server 120 may also have an updated workflow 130 that may be used in conjunction with or to replace the task workflow 114. In such an instance, the device 104 may update the entire workflow 114 to include any new tasks by requesting the updated workflow 130 from the update server 120 prior to executing the workflow 114.

In some embodiments, the device 104 may use the updated setup media 122 in place of the local setup media 112. In such an embodiment, the update server 120 may provide the task modules 132 that may otherwise be obtained from a local copy of the setup media 112. Such an embodiment may be useful for instances where the setup media 112 is not very large and thus transfer times over the Internet 118 and the network 102 may be reasonable.

One or more of the setup task modules 116 may install or configure a remote service provider 134 for operation on the device 104. The remote service provider may be any service that is used by the device 104 and may, in some instances, be an alternative to a locally operating software component or application. For example, a remote service provider 134 may provide an email hosting and delivery solution that may replace a locally executing email hosting and delivery application. In another example, an accounting solution may comprise an accounting service provided through a remote service provider 134 and a thin client that operates on the device 104. Various configurations and software architectures may be setup or configured through the various tasks.

In some embodiments, a workflow may be executed by the device 104 in conjunction with a device 136 connected through the network 102. In some instances, the device 136 may have a storage system 138 such as a hard drive on which an application or service is to be configured. The device 136 may have setup media 140 that contains a task workflow and associated task modules.

A workflow on device 104 may operate in conjunction with device 136 in several different manners. In some embodiments, device 136 may execute a workflow at the same time as device 104 executes a workflow. The two workflows may interact with each other, such as by passing messages or other status back and forth, and tasks within one or both of the workflows may depend on tasks within the other workflow. By interacting with each other, workflows on two different devices may setup or install software components that enable both devices to work together in some applications.

In another embodiment, a multiple device installation may be performed by having one device, such as device 104, perform a workflow. In one such embodiment, device 104 may connect to the storage system 138 and perform task modules 116 that install a component that may be executed by device 136. In another of such embodiments, the device 104 may transmit a message to signal device 136 to perform a specific task module, which may be transmitted from the setup media 112 to device 136 or retrieved from local setup media 140.

An example of a multiple device installation may be in a server environment where individual servers are configured to perform specific tasks. For example, one server may be configured to provide shared directory services while a second server may be configured to provide messaging and email services. The second server may be dependent on the first server for some functions and the first server may similarly be dependent on the second server. If a problem occurs during installation of one of the various components, the setup workflow may be able to detect and resolve the problem before proceeding with further installation steps.

The devices 104 and 136 may be any type of device that may be configured. Some embodiments may be personal computers and server computers, but other devices such as handheld wireless devices, network appliances, network storage devices, network routers and distribution equipment, wireless access points, industrial controllers, or any other configurable device.

Similarly, the network 102 may be any type of communications network, including hardwired and wireless networks. The network 102 may be a point to point connection between two devices, or may be a general purpose network used by many different devices. Wireless networks may include mesh networks, point to point connections, and any other type of architecture.

FIG. 2 is a flowchart illustration of an embodiment 200 showing a method for performing a setup workflow. Embodiment 200 illustrates executing a workflow and saving configuration states after each task is executed. If a problem exists with one of the tasks, the configuration may be reverted to a previous configuration to a point where a user may change an input value or otherwise correct a problem that occurred. At some tasks, an update function may contact a remote server and receive a new task. The new task may be incorporated into the workflow.

The process begins in block 202. The task workflow is read in block 204 and execution of the workflow may begin in block 206.

An initial configuration state is defined in block 208. If an error occurs, it may be possible to revert the installation back to the initial configuration state of block 208.

If the current task is to be updated in block 210, a connection is made to a remote server in block 212. In some cases, the remote server may be located on the Internet, but in other cases, the remote server may be another device on a local area network. After connecting to the remote server in block 212, a new task is received in block 214 and new dependencies for the task in block 216.

In many embodiments, the workflow definition may incorporate many best practices and knowledge about installation of multiple software products, especially the interactions between different products as they are installed. The knowledge embodied in a workflow definition may evolve over time as products are used in different configurations and in different circumstances. The updated tasks that are obtained from a remote server may reflect those best practices and experiences.

Additionally, a software product supplier may develop new options, enhancements, or alternatives for a product. An updated task from a remote server may offer those new options or alternatives to a user. In some instances, a user may have an option to upgrade a version of the product being installed. In other instances, a user may be presented with an option to use a remotely hosted service product in conjunction with or instead of a locally executed software product.

The new task is incorporated into the workflow in block 218. In some instances, a new task may replace an existing task, while in other instances, a new task may be offered as an optional alternative to an existing task. In still other instances, a new task with a complicated list of dependencies may require a complex reworking of a workflow process in order to meet the various dependencies. Each embodiment may use different methods for incorporating new tasks into an existing workflow based on the dependencies.

In some embodiments, dependencies may be defined in an express statement of dependencies. Such expressions may define specific tasks on which a new task is dependent and may include specific values or data that may be processed by preceding tasks. In some instances, such values may be a minimum or maximum value, while in other cases the value may be an exact term.

For example, a new task may be added that uses a specific amount of memory configured in a specific manner. The new task may depend on a memory configuration task and the new task may further depend on the memory configuration task performing a specific configuration with at least a minimum amount of memory defined in that manner. If the new task was added after the memory configuration task was completed, the workflow may return to the memory configuration task and re-run the task with the appropriate values. In some embodiments, a workflow may automatically redo a previous task based on the new task. In other embodiments, a workflow may present a user interface that may alert a user to the change or may pause so that a user may have an option to alter one or more settings before a task is performed again.

After the new task is incorporated into the workflow in block 218, the workflow continues in block 220.

If the task is not to be updated in block 210, the task is executed in block 222. In some instances, a task execution may comprise launching an executable or otherwise performing a task without a user interface. In other instances, a task may comprise presenting a user interface, presenting data, and collecting data and instructions from a user. In some cases, a task may consist of merely a user interface action.

If a problem is detected in block 224, the process may revert-to a previous configuration state in block 226. In some instances, a user interface may be presented that gives a user the option of reverting, skipping the task, ignoring the error, retrying the task, or other options. In other instances, a user may be given an option to revert two, three, or more steps backward in the workflow in order to change a variable, select another option, or take other corrective measures.

If no problem is detected in block 224, the current configuration state is updated in block 228. If more tasks exist in block 230, the workflow continues in block 220. If no more tasks exist in block 230, the process ends in block 232.

Embodiment 200 is merely one example of a method for performing a workflow. In some embodiments, configuration states may be saved at each task, while in other embodiments, configuration states may be saved at predefined locations within the workflow.

Reverting to a previous configuration state may be performed in different manners. In a simple example, the workflow may return to a previous point in the setup process and perform previously executed steps again, some of which may or may not have new parameters. In another example, a workflow manager may return to a previous point in the setup process but may undo any changes made between the last executed step and the reverted state. In such an example, each task may be constructed in a manner that the effects of the task may be undone if such a reversion is executed.

FIG. 3 is a diagram of an embodiment 300 showing how a workflow may be updated. An initial workflow 301 is shown before an update to a task is made and an updated workflow 302 is shown after the update is made. Workflow 301 has one step in the workflow where a task is updated.

Workflow 301 starts in block 306 and proceeds to task 308. The workflow branches into an update task step 310, a task 312, and a decision point 314. The decision point 314 may cause a task 316 to be performed and the process reverts to task 308. The other branch of the workflow has task 318 being performed in parallel with task 312. After both task 312 and 318 are successful, task 320 is performed and the workflow ends in block 322.

The process of updating a task in block 310 is the process of contacting a remote server in block 212 and receiving a new task in block 214 and new task dependencies in block 216. The dependencies and task are incorporated into the workflow in block 218 and the workflow continues in block 220. The process of updating a task is identical to that of embodiment 200 of FIG. 2.

In the updated workflow 302, task 312 has been replaced by an updated task 323. Updated task 323 comprises a decision point 324 that branches the workflow into either task 312 or new task 326.

Workflow 301 illustrates several features of some embodiments of a workflow, including complex error correction logic, branching, and parallel operation.

### BRIEF DESCRIPTION OF THE DRAWINGS

In the drawings,

FIG. 1 is a diagram of an embodiment showing a system with workflow based setup.

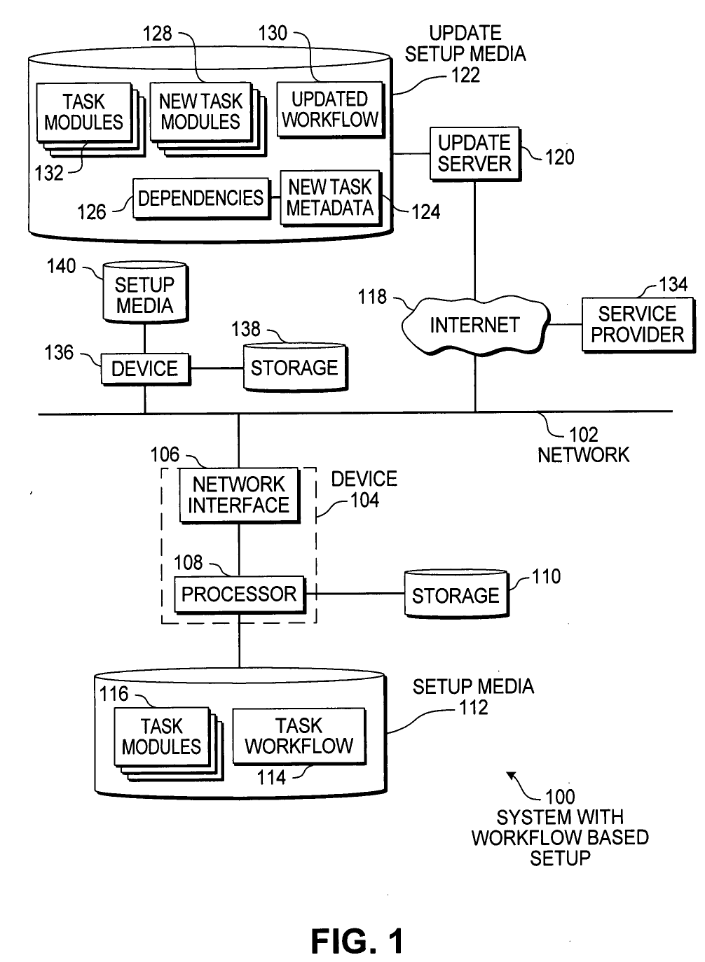

FIG. 2 is a flowchart of an embodiment showing a method for performing a setup workflow.

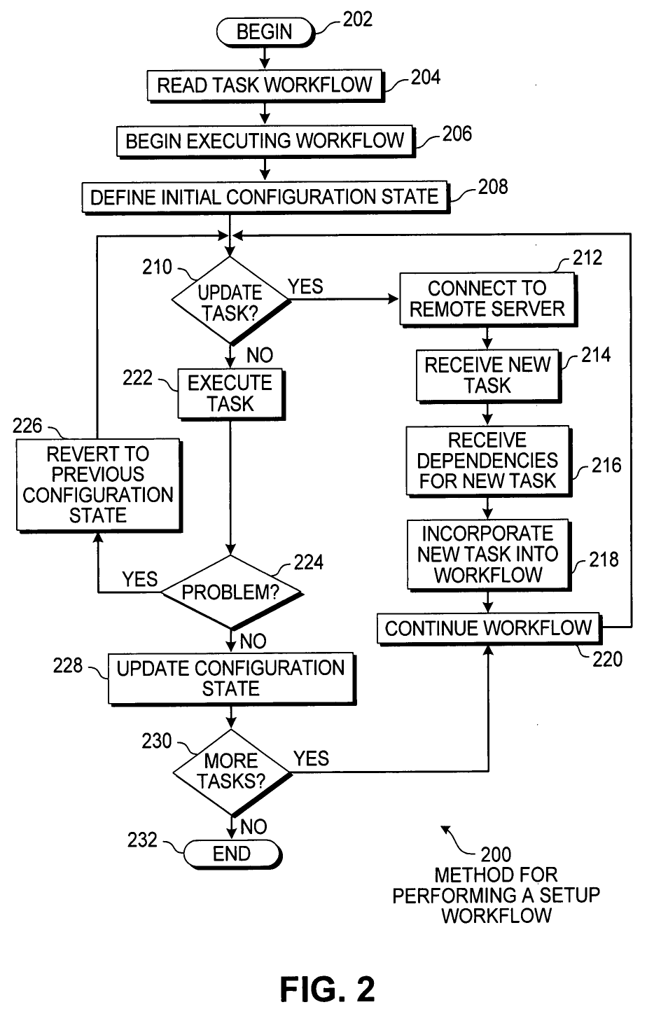

FIG. 3 is a diagram of an embodiment showing an updated workflow.

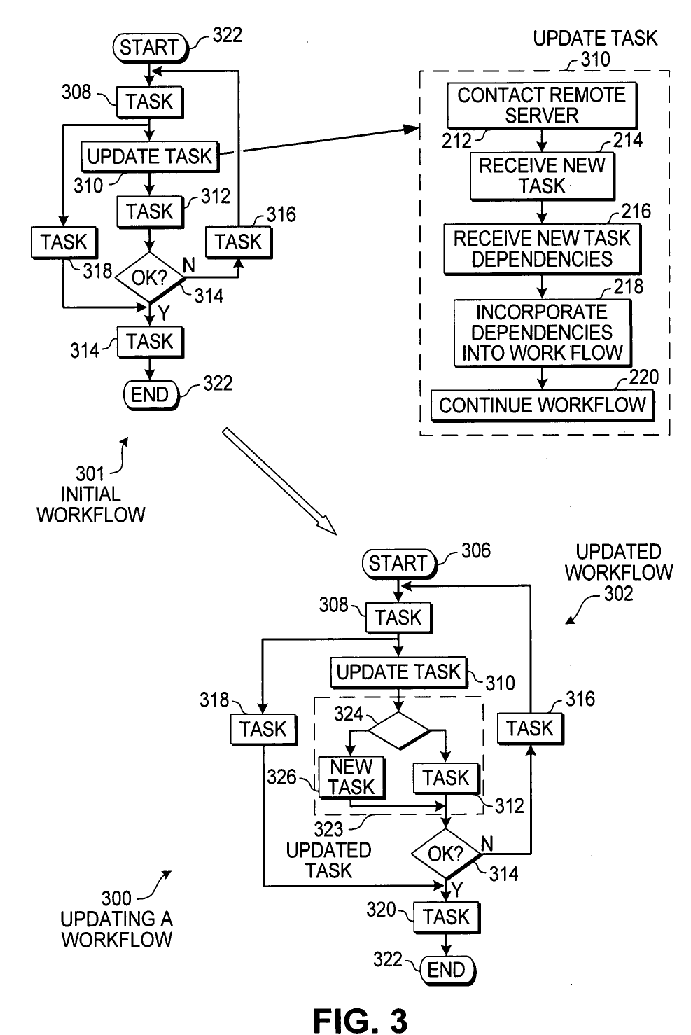

### DETAILED DESCRIPTION

A setup or installation sequence may be defined in a complex workflow manner that may allow branching and error recovery that may include reversion to a previous state in some cases. The workflow may be modified to incorporate new setup tasks that may be determined by querying a remote server during the execution of the workflow.

New tasks may be updated setup components, or may include alternatives for a specific setup task. Alternatives may include installing a local version of a software product, installing a product on another device within a local area network, or configuring to receive a remote service that performs some of the same functions as the local software product.

A workflow framework may include an overall sequence that defines several smaller setup tasks. Each task may, for example, install and configure a single software component, application, or function. Each task may have dependencies on previously performed tasks as well as dependencies on subsequent tasks. At some points throughout a workflow definition, configuration states may be defined as reference points for reverting to a designated configuration state during a setup sequence during error recovery, for example.

Workflow 301 has a defined logic for checking that task 312 is properly executed. After the task 312 is performed, a decision point 314 may determine if an error occurred during task 312 or if some other condition is met. If a problem exists, task 316 may be executed and the process begins again at block 308. The task 316 may not normally be executed in the workflow and may be present as an error correction or diagnostic mechanism. Error detection and compensation logic may be created in any complexity, depending on the embodiment.

Workflows 301 and 302 have branching in different manners. After block 308, the workflow has a forced branch to two parallel paths. In blocks 314 and 324, conditional branches may be used to have the workflow follow one path or another. In some instances, conditional branches may be determined by analyzing or evaluating an expression or by presenting a user interface and requesting input from a user.

Tasks 318 and 312 are on parallel paths of workflows 301 and 302. In some embodiments, both tasks 318 and 312 may be operating simultaneously using various technologies, including multiple threading on a single processor. In some embodiments, task 318 may be performed by one device while task 312 is performed by another device.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
executing a setup workflow comprising a plurality of setup tasks, a plurality of configuration states being defined by a completion of each of said plurality of setup tasks;
for one of said plurality of tasks, performing tasks comprising:
connecting to a remote server;
retrieving a new task;
retrieving a dependency between said new task and a first task being one of said plurality of setup tasks; and
updating said setup workflow to include said new task, said updating comprising defining at least one of said plurality of configuration states to which said setup workflow may revert when a failure is detected in said new task.

2. The method of claim 1, said setup workflow further comprising at least one branch.

3. The method of claim 1, said setup workflow comprising parallel workflows.

4. The method of claim 1, said new task being an alternative task for a first task of said plurality of tasks, said setup workflow comprising a query to determine which of said new task and said first task is to be performed.

5. The method of claim 1, said one of said plurality of tasks comprising a local setup of a software product adapted to perform a function and said new task comprising setup of a remote service to perform said function.

6. The method of claim 5, said remote service being delivered over a wide area network connection.

7. The method of claim 5, said remote service being setup on a device attached to a local area network.

8. The method of claim 1, said dependency comprising a forward dependency between said new task and a subsequent task in said setup workflow.

9. The method of claim 1, said dependency comprising a backward dependency between said new task and a previous task in said setup workflow.

10. The method of claim 1, said new task comprising metadata comprising a network address for setup media.

11. The method of claim 1, said setup workflow being defined in XML.

12. A computer readable medium comprising computer executable instructions adapted to perform the method of claim 1.

13. A system comprising:
a network connection;
a storage device;
a setup workflow stored on said storage device comprising a plurality of setup tasks, a plurality of configuration states being defined by a completion of each of said plurality of setup tasks;
a processor adapted to perform a method comprising:
executing said setup workflow;
for one of said plurality of tasks within said setup workflow, performing a method comprising:
connecting to a remote server;
receiving a new task;
receiving a dependency between said new task and a first task being one of said plurality of setup tasks; and
updating said setup workflow to include said new task, said updating comprising defining at least one of said plurality of configuration states to which said setup workflow may revert when a failure is detected in said new task.

14. The system of claim 13, said new task being an alternative task for a first task of said plurality of tasks, said setup workflow comprising a query to determine which of said new task and said first task is to be performed.

15. The system of claim 13, said one of said plurality of tasks comprising a local setup of a software product adapted to perform a function and said new task comprising setup of a remote service to perform said function.

16. The system of claim 15, said remote service being installed on a device attached to a local area network.

17. The system of claim 15, said dependency comprising a forward dependency between said new task and a subsequent task in said setup workflow.

18. The system of claim 16, said dependency comprising a backward dependency between said new task and a previous task in said setup workflow.

19. A method comprising:
reading a predefined workflow of setup tasks, said workflow comprising a first dependency relationship defined between a first setup task and a second setup task;
for one of said setup tasks, performing a method comprising:
connecting to a remote server;
retrieving a new task, said new task being an alternative task to said first task;
retrieving a second dependency between said new task and a third task being one of said setup tasks; and
updating said setup workflow to include said new task, said updating comprising said second dependency.

20. A computer readable medium comprising computer readable instructions adapted to perform the method of claim 19.
